(19) United States
(12) Patent Application Publication
(10) Pub. No.: US 2025/0078066 A1
(43) Pub. Date: Mar. 6, 2025

(54) METHOD FOR PROVIDING EXCHANGE RATE PREDICTION SYSTEM BASED ON MULTI ARTIFICIAL INTELLIGENCE MODELS

(71) Applicant: SWITCHWON CO., LTD., Busan (KR)

(72) Inventor: Jeong A SEO, Busan (KR)

(21) Appl. No.: 18/812,167

(22) Filed: Aug. 22, 2024

(30) Foreign Application Priority Data
Aug. 31, 2023 (KR) 10-2023-0115134

(51) Int. Cl. G06Q 20/38

(52) U.S. Cl. CPC G06Q 20/381

(57) ABSTRACT

An embodiment relates to an exchange rate prediction method based on multi artificial intelligence models performed by a server, the exchange rate prediction method includes providing a currency exchange service application to a user terminal, and receiving input from the user terminal of the type of structured data and artificial intelligence model to be used for exchange rate prediction, a country to be exchanged, and a target exchange rate value, performing learning by inputting the input structured data into the type of artificial intelligence model among multi artificial intelligence models, inputting current structured data into the learned model to calculate exchange rate prediction information, and providing the target exchange rate value and the calculated exchange rate prediction information, and receiving a correction value for the target exchange rate value from the user terminal.

### CROSS-REFERENCE TO RELATED APPLICATION

This application is based on and claims priority under 35 U.S.C. § 119 to Korean Patent Application No. 10-2023-0115134, filed on Aug. 31, 2023, in the Korean Intellectual Property Office, the disclosure of which is incorporated by reference herein in its entirety.

### BACKGROUND

The present disclosure relates to an exchange rate prediction system based on multi artificial intelligence models and a method for providing the same, and more specifically, relates to a technology that extracts structured data and unstructured data from large events that suddenly occur and builds multi artificial intelligence models based on the extracted data to predict future exchange rate fluctuations in the short term.

Recently, exchange rates between respective countries have been changed at shorter intervals than before according to the rapidly changing international situation.

Exchange rates usually fluctuate due to the influence of large events such as interest rate hikes, economic crises, and the invention of new technologies, but since these large events usually have precursory symptoms, the fluctuations in exchange rates may also be predicted by anticipating these events.

Meanwhile, when predicting exchange rates, large events such as those described above may be pre-reflected in the exchange rate. Alternatively, these large events may have an immediate or gradual impact on the exchange rate over the next 1 or 2 days.

In general, it is not easy to predict the exchange rate in the distant future, but the impact of the Korean exchange rate over the next 1 or 2 days after the initial occurrence of a specific event (e.g., US bank failure, Chinese real estate crisis, etc.) may also be predicted to some extent. However, prior technologies have a problem in that they are designed to predict exchange rates only using a consistent algorithm, without considering the period during which these events influence the exchange rate.

### SUMMARY

The present disclosure extracts structured data and unstructured data from suddenly occurring large events, usually in addition to large events that are previously reflected in exchange rate prediction such as interest rate increase, predict short-term exchange rates based thereon, and enable customers to utilize these on their own.

Also, the present disclosure intuitively provides a difference between the predicted exchange rate, the actual exchange rate, and the target exchange rate value set by the user through a graph-like method.

Objects to be achieved by the present disclosure are not limited to the objects described above, and other objects not described may be clearly understood from the description below.

As technical means for achieving the above-described technical problems, an exchange rate prediction method based on multi artificial intelligence models performed by a server according to an embodiment of the present disclosure, the exchange rate prediction method may include (a) providing a currency exchange service application to a user terminal, and receiving input from the user terminal of the type of structured data and artificial intelligence model to be used for exchange rate prediction, a country to be exchanged, and a target exchange rate value; (b) performing learning by inputting the input structured data into the type of artificial intelligence model among multi artificial intelligence models; (c) inputting current structured data into the learned model to calculate exchange rate prediction information; and (d) providing the target exchange rate value and the calculated exchange rate prediction information, and receiving a correction value for the target exchange rate value from the user terminal.

In addition, in step (a), the structured data may include economic real variables, economic derived variables, and psychological derived data. However, it is not limited to this, and various economic variables may be included in the structured data.

In addition, in step (a), a selection input for multi artificial intelligence models may be received from the user terminal, and at least one structured data to be learned by each artificial intelligence model may be selected for each artificial intelligence model.

In addition, in step (b), the artificial intelligence model may use the selected structured data as an input value and perform learning according to a preset algorithm, so that when current structured data is input, the artificial intelligence model may be learned to output the exchange rate value for each date.

In addition, in step (c), the artificial intelligence model may receive a selection input for any one artificial intelligence model among multi artificial intelligence models each of which completed learning using different learning data and machine learning methods.

In addition, the artificial intelligence model may be learned according to any one of the learning methods of XG Boost, Decision Tree, Logistic Regression, Random Forest, Support Vector Classifier, LSTM, and Ensemble Bagging.

In addition, step (c) may further include (c+1) comparing a predicted exchange rate value in the calculated exchange rate prediction information with the target exchange rate value, and determining that the exchange rate prediction information reaches the input target exchange rate value when an amount of change per preset unit of the predicted exchange rate value converges on the target exchange rate value within a preset period.

In addition, in step (c+1), the predicted exchange rate value in the calculated exchange rate prediction information may be compared with the target exchange rate value, and when the amount of change per preset unit of the predicted exchange rate value does not converge on the target exchange rate value within the preset period, that the exchange rate prediction information may be determined that does not reach the input target exchange rate value.

In addition, in step (d), a predicted exchange rate-time graph may be generated based on the exchange rate prediction information output by the artificial intelligence model, the predicted exchange rate-time graph and an actual exchange rate-time graph may be displayed by being overlapped, and a predicted exchange rate-time graph may be created separately for each artificial intelligence model selected by the user terminal to provide information on performance of each artificial intelligence model to the user terminal.

In addition, in step (d), when a correction value for the target exchange rate value is received from the user terminal, the modified target exchange rate value may be reflected, and steps (a) to (c) may be performed again.

In addition, step (a) may further include additionally selecting unstructured data from the user terminal, extracting the unstructured data via web crawling by the server, and inputting the unstructured data into an LSTM model to extract structured data, and the extracted structured data may be used to learn the artificial intelligence model selected by the user terminal together with economic real variables, economic derived variables, and psychological derived data.

In addition, the unstructured data may include at least one of news articles, Korea Monetary Policy Committee meeting records, and US FOMC meeting records, and in step (a), the server may perform a preprocessing process in which unstructured data is input into a natural language processing model, and sentences or words extracted from the unstructured data is vectorized.

In addition, the exchange rate prediction information may be exchange rate prediction information for a period within a week.

An exchange rate prediction server based on multi artificial intelligence models according to an embodiment of the present disclosure may include a memory storing a program for performing an exchange rate prediction method based on multi artificial intelligence models; and a processor for executing the program, in which the method may include (a) providing a currency exchange service application to a user terminal, and receiving input from the user terminal of the type of structured data and artificial intelligence model to be used for exchange rate prediction, a country to be exchanged, and a target exchange rate value, (b) performing learning by inputting the input structured data into the type of artificial intelligence model among multi artificial intelligence models, (c) inputting current structured data into the learned model to calculate exchange rate prediction information, and (d) providing the target exchange rate value and the calculated exchange rate prediction information, and receiving a correction value for the target exchange rate value from the user terminal.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a structural diagram of an exchange rate prediction system based on multi artificial intelligence models according to an embodiment of the present disclosure;

FIG. 2 is a block diagram showing an internal configuration of an exchange rate prediction server based on multi artificial intelligence models according to an embodiment of the present disclosure;

FIG. 3 is an example diagram of economic real variables used as learning data for multi artificial intelligence models according to an embodiment of the present disclosure;

FIG. 4 is an example diagram of economic derived variables used as learning data for multi artificial intelligence models according to an embodiment of the present disclosure;

FIG. 5 is an example diagram of psychological derived variables used as learning data for multi artificial intelligence models according to an embodiment of the present disclosure; and

FIG. 6 is a flowchart of an execution order of a method for providing an exchange rate prediction system based on multi artificial intelligence models according to an embodiment of the present disclosure.

### DETAILED DESCRIPTION

Hereinafter, embodiments of the present disclosure will be described in detail with reference to the attached drawings such that those skilled in the art may easily implement the present disclosure. However, the present disclosure may be implemented in many different forms and is not limited to the embodiments described herein. In order to clearly explain the present disclosure in the drawings, parts unrelated to the description are omitted, and similar parts are given similar reference numerals throughout the specification.

Throughout the specification, when a part is said to be “connected” to another part, this includes not only cases where it is “directly connected,” but also cases where it is “electrically connected” with another element therebetween. Additionally, when a part “includes” a certain component, this means that it may further include other components rather than excluding other components, unless specifically stated to the contrary.

In this specification, ‘part’ includes a unit realized by hardware, a unit realized by software, and a unit realized using both. Additionally, one unit may be realized using two or more pieces of hardware, and two or more units may be realized using one piece of hardware. Meanwhile, ‘˜ part’ is not limited to software or hardware, and ‘˜ part’ may be configured to reside in an addressable storage medium or may be configured to reproduce one or more processors. Therefore, as an example, ‘˜ part’ includes components such as software components, object-oriented software components, class components, and task components, processes, functions, properties, and procedures, subroutines, segments of program code, drivers, firmware, microcode, circuits, data, databases, data structures, tables, arrays, and variables. The functions provided within the components and ‘parts’ may be combined into a smaller number of components and ‘parts’ or may be further separated into additional components and ‘parts’. Additionally, components and ‘parts’ may be implemented to regenerate one or more CPUs within a device or a secure multimedia card.

The “terminal” mentioned below may be implemented as a computer or portable terminal that may connect to a server or other terminal through a network. Here, the computer may include, for example, a laptop equipped with a web browser, a desktop, a laptop, a VR HMD (e.g., HTC VIVE, Oculus Rift, GearVR, DayDream, PSVR, etc.), etc. Here, the VR HMD includes Stand Alone models (e.g., Deepon, PICO, etc.) implemented independently from for PC (e.g., HTC VIVE, Oculus Rift, FOVE, Deepon, etc.), for mobile (e.g., GearVR, DayDream, Storm Magic, Google Cardboard, etc.), and for console (PSVR). A portable terminal is, for example, a wireless communication device that guarantees portability and mobility, and may include smart phones, tablet PCs, and wearable devices in addition to various devices equipped with communication modules such as Bluetooth (BLE, Bluetooth Low Energy), NFC, RFID, ultrasonic, infrared, WiFi, and LiFi. In addition, “network” refers to a connection structure that allows information exchange between nodes such as terminals and servers, and includes a local area network (LAN), a wide area network (WAN), and the Internet (WWW: World Wide Web), wired and wireless data communication network, telephone network, wired and wireless television communication network, etc. Examples of wireless data communication networks include 3G, 4G, 5G, 3GPP (3rd Generation Partnership Project), LTE (Long Term Evolution), WIMAX (World Interoperability for Microwave Access), Wi-Fi, Bluetooth communication, infrared communication, ultrasound communication, Visible Light Communication (VLC), LiFi, etc., but is not limited thereto.

The present disclosure is a technology that extracts structured data and unstructured data from large events that suddenly occur and builds multi artificial intelligence models based on the extracted data to predict future exchange rate fluctuations in the short term through an exchange rate prediction system based on multi artificial intelligence models and a method for providing the same.

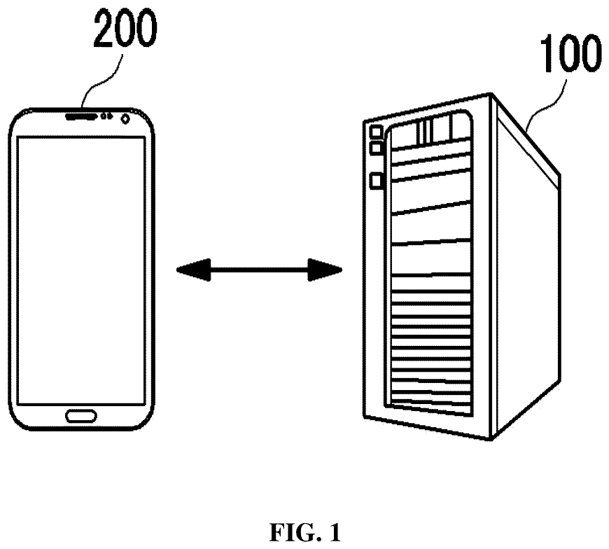

To this end, an exchange rate prediction system based on multi artificial intelligence models according to an embodiment of the present disclosure may be configured to include a server 100 and a user terminal 200, as shown in FIG. 1.

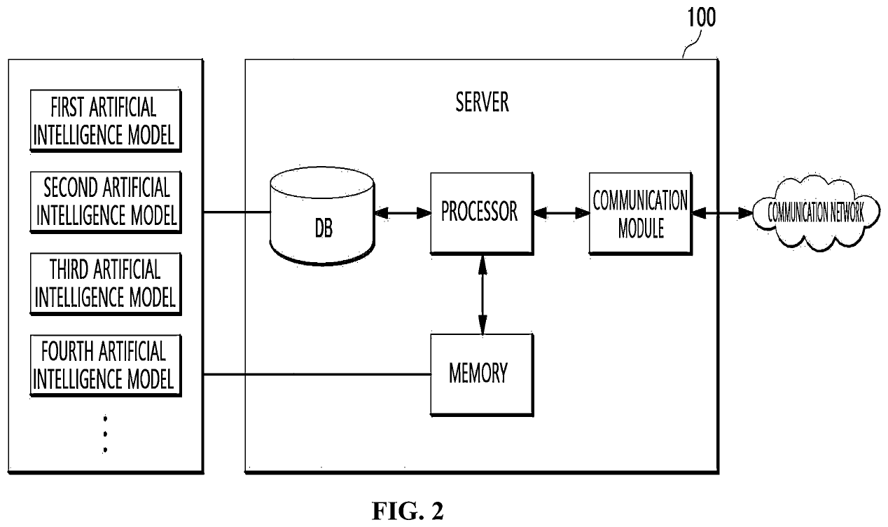

As shown in FIG. 2, the server 100 performs an exchange rate prediction method based on multi artificial intelligence, and may be configured to include a memory in which a program for building a machine learning model and a program (or application) for providing exchange rate prediction and a user interface (UI) on the user terminal 200 are stored, a processor that executes the programs described above, and a DB (Data Base). Here, the processor may perform various functions in accordance with the execution of the program stored in the memory.

Additionally, the server 100 may be connected to a communication network wired or wirelessly via a communication module, and may be able to communicate with at least one user terminal 200 or other servers connected to the same network or an external network.

Next, the user terminal 200 according to an embodiment of the present disclosure includes all electronic devices that may be operated by the user, such as a typical smartphone, tablet PC, desktop, and laptop, and may be a terminal in which a program or application that runs and provides a UI (User Interface) provided from the server 100 is installed.

The server 100 of the system configured as described above provides a currency exchange service application to the user terminal 200, and may receive the structured data, the type of the artificial intelligence model, the country to be exchanged, and the target exchange rate value to be used for predicting exchange rates from the user terminal 200.

The method by which the user terminal 200 inputs the structured data, the type of the artificial intelligence model, the country to be exchanged, and the target exchange rate value to the server 100 may be implemented in various ways depending on the embodiment, and in a preferred embodiment, the server 100 may use the currency exchange service application included in the UI provided to the user terminal 200.

Here, the structured data includes economic real variables, economic derived variables, and psychological derived data, and may include various indexes announced by domestic and foreign banks, government economic agencies, and associations, etc.

The economic real variables, the economic derived variables, and the psychological derived data using as the structured data in the present disclosure may exist in countless combinations, such as data from various countries alone or through comparisons between respective countries, but for explanation purposes, in the below description, individual indexes of Korea and the United States or data through comparison between Korea and the United States are used as examples, and according to various additional embodiments of the present disclosure, more types of data may be used as structured data.

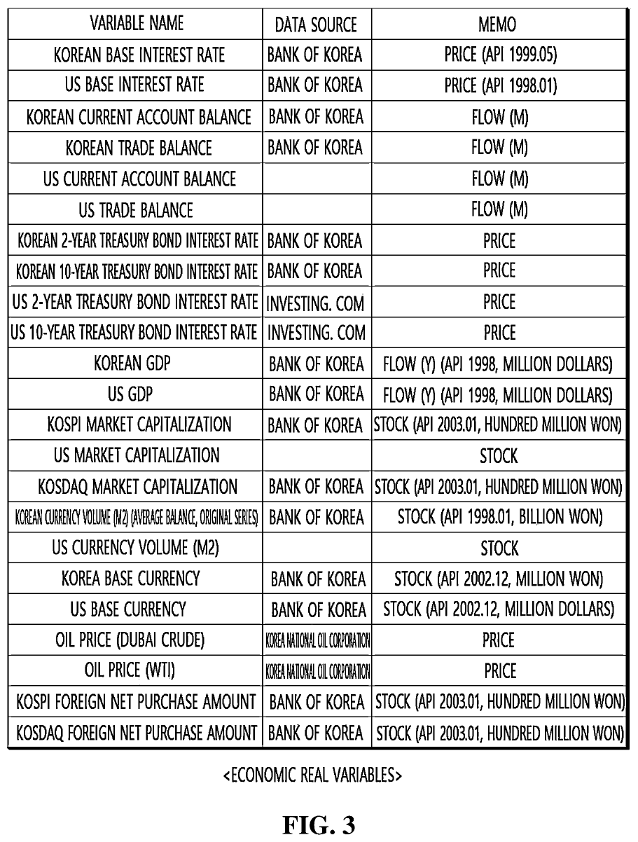

As shown in FIG. 3, among the structured data according to the embodiment, the economic real variables may include Korean base interest rate announced by the Bank of Korea, US base interest rate, Korean current account balance, Korean trade balance, US current account balance, US trade balance, Korean 2-year Treasury bond interest rate, Korean 10-year Treasury bond interest rate, US 2-year Treasury bond interest rate, US 10-year Treasury bond interest rate, Korean GDP, US GDP, KOSPI market capitalization, US market capitalization, KOSDAQ market capitalization, Korean currency volume, US currency volume, Korea base currency, US base currency, oil price (Dubai crude), oil price (WTI), KOSPI foreign net purchase amount, and KOSDAQ foreign net purchase amount.

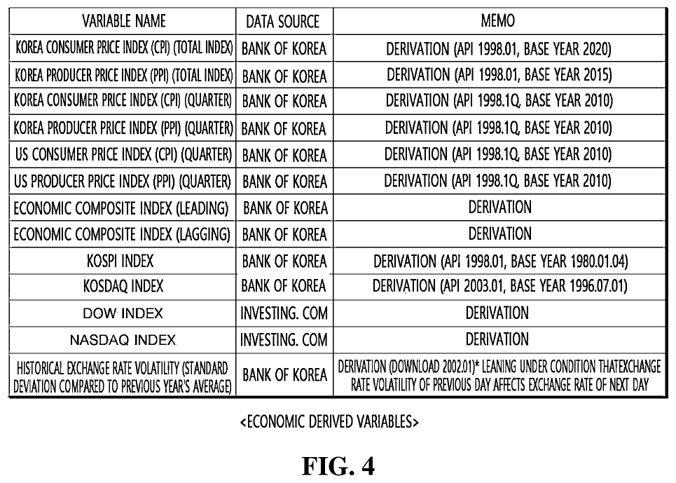

In addition, with reference to FIG. 4, the economic derived variables may include Korca consumer price index (CPI) total index, Korea producer price index (PPI) total index, Korea consumer price index (CPI) by quarter, Korea producer price index (PPI) by quarter, US consumer price index (CPI), US producer price index (PPI) by quarter, leading economic composite index, lagging economic composite index, KOSPI index, KOSDAQ index, DOW INDEX, NASDAQ INDEX, and historical exchange rate volatility (based on standard deviation compared to the previous year's average).

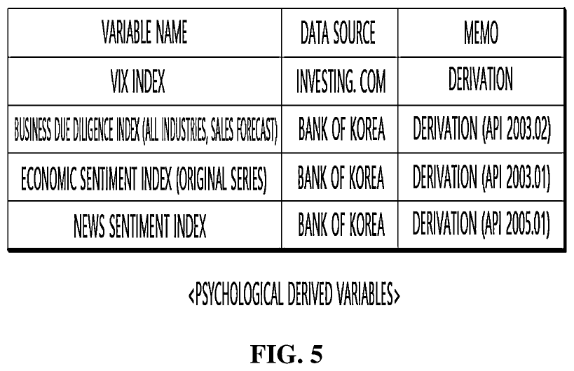

Subsequently, the psychological derived variables shown in FIG. 5 may include VIX index (index created by the Chicago Board Options Exchange (CBOE) in the United States to measure stock market volatility), business due diligence index (sales forecast for all industries) published by the Bank of Korea, economic sentiment index (original series), and news sentiment index.

In addition to the structured data as described above, according to various embodiments of the present disclosure, the structured data may further include all information on interest rates, consumer price index, GDP, GDP growth rate, unemployment rate, trade balance, current account balance, political factors, natural disasters, emergency accidents, foreign investment, oil prices, the policies of each country's government and central bank, etc.

Representatively, Internet pages from around the world, such as OECD iLibrary Statistics, World Bank Open Data, World Development Indexes, UNdata, UNCTADstat, IMF Data Mapper, IMF World Economic Outlook Database, BIS Statistics, Asian Development Bank, and EuroStat, which are released by each organization through the Internet or official documents, and macro indexes including figures, charts, and images included in each page thereof may be included in the structured data, and all other index values that have the potential to affect exchange rates may be used as structured data in the present disclosure.

These various structured data are provided from the user terminal 200 to the server 100 in various methods, and the structured data provided by the server 100 is inputted into the received type of the artificial intelligence model among multi stored artificial intelligence models for learning.

Meanwhile, according to an additional embodiment of the present disclosure, the server 100 may additionally select unstructured data in addition to the structured data and directly calculate the structured data therethrough.

Here, the unstructured data may include at least one of news articles, Korea Monetary Policy Committee meeting records, and US FOMC meeting records.

In the embodiment, the server 100 performs a preprocessing process in which the unstructured data is extracted as text data via web crawling that performs Internet searches over the keywords stored in the DB or the memory, or received from the user terminal 200 (e.g., keywords that may affect exchange rates such as oil prices, war, commercialization, and mergers and acquisitions), and then the text data is input into a natural language processing model separated from the artificial intelligence model to vectorize the extracted sentences or words, and thereby the unstructured data is extracted as the structured data.

Here, the LSTM (Long Short Term Memory) model may be typically used as the natural language processing model, and in addition, other models learned by the same learning method as the artificial intelligence model may also be used.

The structured data extracted as described above may be used for learning the artificial intelligence model selected by the user terminal 200 along with the economic real variables, economic derived variables, and psychological derived data. Therefore, in addition to the previously provided structured data, the users may add learning data they have set as learning data.

With reference to FIG. 2 again, the server 100 stores multi different artificial intelligence models in the memory or the DB, and each artificial intelligence model may be learned using different learning data and machine learning methods.

In this case, the user may select which artificial intelligence model to learn from the server 100 via the user terminal 200 and select at least one structured data to be learned by the selected artificial intelligence model.

Therefore, the server 100 of the present disclosure may secure multi artificial intelligence models learned with different learning methods and learning data, and provide various analysis results accordingly.

In addition, the artificial intelligence model selected from the user terminal 200 uses the selected structured data as an input value and performs learning according to a preset algorithm, so that when the current structured data is input, the artificial intelligence model is learned to output the exchange rate value for each date.

In this case, in the algorithm for learning the artificial intelligence model, the artificial intelligence model may be any one of the learning methods of XG Boost, Decision Tree, Logistic Regression, Random Forest, Support Vector Classifier, LSTM, and Ensemble Bagging according to unsupervised learning and supervised learning, and learning may also be done using other learning methods according to various embodiments.

Since the learning method of the artificial intelligence model described above corresponds to prior art, it will not be described in detail in this specification.

Next, the server 100 inputs the current structured data into the learned model to calculate exchange rate prediction information.

The exchange rate prediction information includes the predicted exchange rate value for each date in the future or within a week in the past, based on the date on which the current structured data is input.

The server 100 compares the predicted exchange rate value in the calculated exchange rate prediction information with the target exchange rate value input from the user terminal 200, and determines that the exchange rate prediction information reaches the input target exchange rate value when an amount of change per preset unit of the predicted exchange rate value (such as the tendency index indicating the fluctuation range or fluctuation trend of the exchange rate by date) converges on the target exchange rate value within the preset period.

On the other hand, when the amount of change per preset unit of the predicted exchange rate value does not converge on the target exchange rate value within the preset period, it is determined that the exchange rate prediction information does not reach the input target exchange rate value, and thereby information on whether the target exchange rate received from the user terminal 200 may be realized, on the possibility of realization, and on the date by which it will be realized may be calculated.

Next, the server 100 may provide the target exchange rate value and the calculated exchange rate prediction information in the UI form through a currency exchange service application or a program of the user terminal 200.

In this case, the calculated exchange rate prediction information may be implemented and provided in various embodiments, but in a preferred embodiment, a predicted exchange rate-time graph is generated based on the exchange rate prediction information output by the artificial intelligence model, the predicted exchange rate-time graph and an actual exchange rate-time graph are displayed by being overlapped, and a predicted exchange rate-time graph is created separately for each artificial intelligence model selected by the user terminal 200. Therefore, the calculated exchange rate prediction information may be provided together with information on the type and performance (version, hit rate, performance, etc.) of the artificial intelligence model used to calculate the relevant information.

Here, when determining that the predicted exchange rate value does not reach the target exchange rate value, the server 100 may perform the entire process of calculating the exchange rate prediction information again in which a correction value for the target exchange rate value is received from the user terminal 200, the modified target exchange rate value is reflected, and then the artificial intelligence model, learning data, and the like may be selected again.

Therefore, the users are not provided with the exchange rate prediction information calculated by a single model, but are provided with multi exchange rate prediction information calculated by artificial intelligence models differently learned with various data, which may be used for currency exchange or investment.

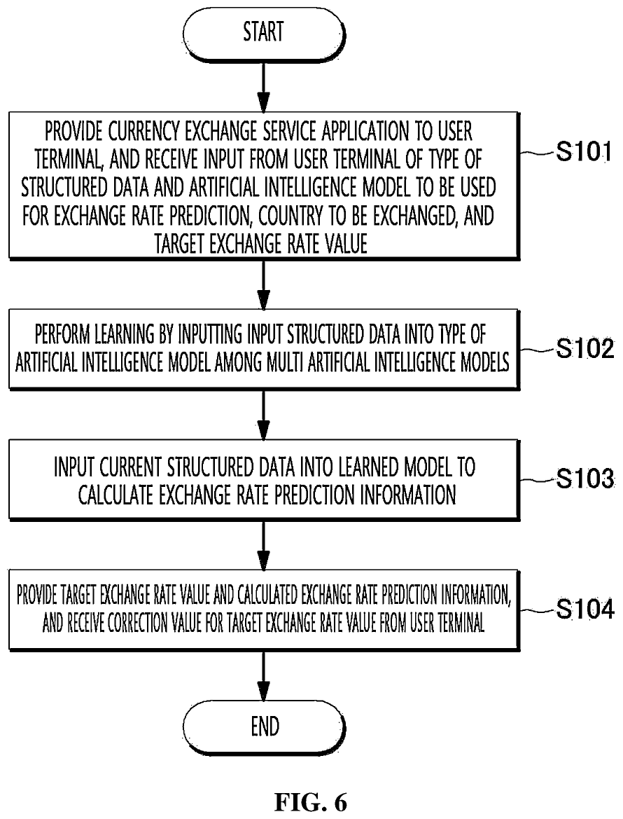

Below, with reference to FIG. 6, the execution order of the method for providing an exchange rate prediction system based on multi artificial intelligence models performed by the server 100 according to an embodiment of the present disclosure will be described once again.

First, the server 100 provides the currency exchange service application to the user terminal 200, and receives input from the user terminal 200 of the type of structured data and artificial intelligence model to be used for exchange rate prediction, the country to be exchanged, and the target exchange rate value (S101).

Afterwards, learning is performed by inputting the input structured data into the type of artificial intelligence model among multi artificial intelligence models (S102), and the current structured data is input into the learned model to calculate the exchange rate prediction information (S103).

Next, the target exchange rate value and the calculated exchange rate prediction information are provided, and a correction value for the target exchange rate value is received from the user terminal 200 (S104).

The present disclosure provides an exchange rate prediction system based on multi artificial intelligence models so that structured data and unstructured data may be extracted from suddenly occurring various events, usually in addition to large events that are already reflected in exchange rate prediction such as interest rate increase, the short-term exchange rate may be predicted based thereon, and customers may utilize these on their own.

In addition, by intuitively providing a difference between the predicted exchange rate, the actual exchange rate, and the target exchange rate value set by the user through a graph-like method, it is possible to perform an exchange rate prediction function that is more intuitive and has better visibility than the conventional exchange rate prediction system.

One embodiment of the present disclosure may also be implemented in the form of a recording medium containing instructions executable by a computer, such as program modules executed by a computer. Computer-readable media may be any available media that may be accessed by a computer and includes all volatile and non-volatile media, and removable and non-removable media. Additionally, computer-readable media may include all computer storage media. Computer storage media includes all volatile and non-volatile, and removable and non-removable media implemented in any method or technology for storage of information such as computer-readable instructions, data structures, program modules, or other data.

Although the method and the system of the present disclosure are described with respect to specific embodiments, some or all of their components or operations may be implemented using a computer system having a general-purpose hardware architecture.

The foregoing description of the present disclosure is for illustrative purposes only, and those skilled in the art will understand that the present disclosure may be easily modified into other specific forms without changing its technical idea or essential features. Therefore, the embodiments described above should be understood in all respects as illustrative and not restrictive. For example, each component described as single may be implemented in a distributed manner, and similarly, components described as distributed may also be implemented in a combined form.

The scope of the present disclosure is indicated by the claims described below rather than the detailed description above, and all changes or modified forms derived from the meaning and scope of the claims and their equivalent concepts should be construed as being included in the scope of the present disclosure.

What is claimed is:

1. An exchange rate prediction method based on multi artificial intelligence models performed by a server, the exchange rate prediction method comprising:
(a) providing a currency exchange service application to a user terminal, and receiving input from the user terminal of the type of structured data and artificial intelligence model to be used for exchange rate prediction, a country to be exchanged, and a target exchange rate value;
(b) performing learning by inputting the input structured data into the type of artificial intelligence model among multi artificial intelligence models;
(c) inputting current structured data into the learned model to calculate exchange rate prediction information; and
(d) providing the target exchange rate value and the calculated exchange rate prediction information, and receiving a correction value for the target exchange rate value from the user terminal.

2. The exchange rate prediction method based on multi artificial intelligence models according to claim 1, wherein.
in step (a), the structured data includes economic real variables, economic derived variables, and psychological derived data.

3. The exchange rate prediction method based on multi artificial intelligence models according to claim 2, wherein,
in step (a), a selection input for multi artificial intelligence models is received from the user terminal, and at least one structured data to be learned by each artificial intelligence model is selected for each artificial intelligence model.

4. The exchange rate prediction method based on multi artificial intelligence models according to claim 1, wherein,
in step (b), the artificial intelligence model uses the selected structured data as an input value and performs learning according to a preset algorithm, so that when current structured data is input, the artificial intelligence model is learned to output the exchange rate value for each date.

5. The exchange rate prediction method based on multi artificial intelligence models according to claim 1, wherein,
in step (c), the artificial intelligence model receives a selection input for any one artificial intelligence model among multi artificial intelligence models each of which completed learning using different learning data and machine learning methods.

6. The exchange rate prediction method based on multi artificial intelligence models according to claim 5, wherein
the artificial intelligence model is learned according to any one of the learning methods of XG Boost, Decision Tree, Logistic Regression, Random Forest, Support Vector Classifier, LSTM, and Ensemble Bagging.

7. The exchange rate prediction method based on multi artificial intelligence models according to claim 1, wherein
step (c) further includes (c+1) comparing a predicted exchange rate value in the calculated exchange rate prediction information with the target exchange rate value, and determining that the exchange rate prediction information reaches the input target exchange rate value when an amount of change per preset unit of the predicted exchange rate value converges on the target exchange rate value within a preset period.

8. The exchange rate prediction method based on multi artificial intelligence models according to claim 7, wherein,
in step (c+1), the predicted exchange rate value in the calculated exchange rate prediction information is compared with the target exchange rate value, and when the amount of change per preset unit of the predicted exchange rate value does not converge on the target exchange rate value within the preset period, the exchange rate prediction information is determined that does not reach the input target exchange rate value.

9. The exchange rate prediction method based on multi artificial intelligence models according to claim 1, wherein,
in step (d), a predicted exchange rate-time graph is generated based on the exchange rate prediction information output by the artificial intelligence model, the predicted exchange rate-time graph and an actual exchange rate-time graph are displayed by being overlapped, and a predicted exchange rate-time graph is created separately for each artificial intelligence model selected by the user terminal to provide information on performance of each artificial intelligence model to the user terminal.

10. The exchange rate prediction method based on multi artificial intelligence models according to claim 1, wherein,
in step (d), when a correction value for the target exchange rate value is received from the user terminal, the modified target exchange rate value is reflected, and steps (a) to (c) are performed again.

11. The exchange rate prediction method based on multi artificial intelligence models according to claim 1, wherein
step (a) further includes additionally selecting unstructured data from the user terminal, extracting the unstructured data via web crawling by the server, and inputting the unstructured data into an LSTM model to extract structured data, and the extracted structured data is used to learn the artificial intelligence model selected by the user terminal together with economic real variables, economic derived variables, and psychological derived data.

12. The exchange rate prediction method based on multi artificial intelligence models according to claim 11, wherein
the unstructured data includes at least one of news articles, Korea Monetary Policy Committee meeting records, and US FOMC meeting records, and
in step (a), the server performs a preprocessing process in which unstructured data is input into a natural language processing model, and sentences or words extracted from the unstructured data is vectorized.

13. The exchange rate prediction method based on multi artificial intelligence models according to claim 1, wherein
the exchange rate prediction information is exchange rate prediction information for a period within a week.

14. An exchange rate prediction server based on multi artificial intelligence models, comprising:
a memory storing a program for performing an exchange rate prediction method based on multi artificial intelligence models; and
a processor for executing the program,
wherein the method includes:
providing a currency exchange service application to a user terminal, and receiving input from the user terminal of the type of structured data and artificial intelligence model to be used for exchange rate prediction, a country to be exchanged, and a target exchange rate value,
performing learning by inputting the input structured data into the type of artificial intelligence model among multi artificial intelligence models,
inputting current structured data into the learned model to calculate exchange rate prediction information, and
providing the target exchange rate value and the calculated exchange rate prediction information, and receiving a correction value for the target exchange rate value from the user terminal.
